(19) United States
(12) Patent Application Publication
(10) Pub. No.: US 2026/0100453 A1
(43) Pub. Date: Apr. 9, 2026

(54) Lightweight High Temperature Battery

(71) Applicant: Wright Electric Inc., Ballston Spa, NY (US)

(72) Inventors: Aaron ROWE, Toluca Lake, CA (US); Harrison W. STEENBAKKERS, Northville, NY (US); Colin TSCHIDA, Ballston Spa, NY (US)

(21) Appl. No.: 18/905,060

(22) Filed: Oct. 2, 2024

Related U.S. Application Data
(60) Provisional application No. 63/542,029, filed on Oct. 2, 2023.

(51) Int. Cl. H01M 50/121; H01M 10/39; H01M 10/615

(52) U.S. Cl. CPC H01M 50/121; H01M 10/39; H01M 10/615

(57) ABSTRACT

A battery system has a casing forming an interior chamber. The casing is comprised of a polymer. The battery system has a chemically active material contained by the interior chamber. The polymer withstands heat generated by the chemically active material. The heat is a function of a melting point of the chemically active material.

### PRIORITY

### This patent application claims priority from provisional United States patent application number 63/542,029 filed October 2, 2023, entitled, “LIGHTWEIGHT HIGH TEMPERATURE BATTERY,” and naming Aaron Rowe et al. as inventors, the disclosure of which is incorporated herein, in its entirety, by reference.

### FIELD

Illustrative embodiments of the invention generally relate to battery-powered systems and, more particularly, various embodiments of the invention relate to battery-powered aircraft.

### BACKGROUND

Traditional aircraft are predominantly powered by fossil fuels, which contribute to environmental pollution and are subject to fluctuating costs. Recent advancements have seen the development of electric aircraft, which utilize battery technology to reduce emissions and operational costs. Battery-powered aircraft face limitations in range, power output, and battery life, which hinder widespread adoption.

### SUMMARY OF VARIOUS EMBODIMENTS

In accordance with one embodiment of the invention, a battery system has a casing forming an interior chamber. The casing is comprised of a polymer. The battery system has a chemically active material contained by the interior chamber. The polymer withstands heat generated by the chemically active material. The heat is a function of a melting point of the chemically active material.

In some embodiments, at least 70% of the casing is comprised of the polymer. The polymer may be comprised of a least one of: polyetheretherketone (PEEK), polyetherimide (PEI), or a combination of polyurethane and polyacrylate. The chemically active material may include molten or heat-softened lithium.

The interior chamber may be divided into an anode chamber and a cathode chamber. The interior chamber may be divided by a solid electrolyte.

The battery system may have a temperature control system configured to separately adjust a first temperature of the anode chamber and a second temperature of the cathode chamber.

The battery system may have a temperature control system including a heating element electrically coupled to the chemically active material. The temperature control system may have a controller configured to heat, using the heating element, the chemically active material as a function of the melting point of the chemically active material.

The casing may be 3D printed. The casing may be a cell casing. The battery system may have pack casing comprised of a polymer.

In some embodiments, the battery system has multiple cells, each housed in cell casing, and a temperature control system. The temperature control system may heat a portion of the cells using an external power source and heat the remaining portion of the cells using the first portion of the cells.

In accordance with one embodiment of the invention, a battery system has a polymer casing forming an interior chamber and molten lithium contained by the interior chamber.

In some embodiments, the battery system includes a temperature control system, which heats the battery system to an initial operating temperature using an external power source and maintains a battery temperature using energy stored by the battery system.

### BRIEF DESCRIPTION OF THE DRAWINGS

Those skilled in the art should more fully appreciate advantages of various embodiments of the invention from the following “Description of Illustrative Embodiments,” discussed with reference to the drawings summarized immediately below.

FIG. 1 is a block diagram showing a battery system in accordance with various embodiments.

FIGS. 2 is a perspective view schematically showing empty cell casings of the battery system in accordance with various embodiments.

FIGS. 3A-B are perspective views schematically showing pack casing and cell casing of the battery system in accordance with various embodiments.

FIG. 4 is a cross-sectional view showing a battery cell in accordance with various embodiments.

FIG. 5 is a block diagram showing a computing device in accordance with various embodiments.

### DESCRIPTION OF ILLUSTRATIVE EMBODIMENTS

In illustrative embodiments, a high-power density battery has a lightweight casing made from polymer materials. Inside the casing, the battery has at least one active material heated near or above its melting point, enhancing energy density and rate capability through increased transport and reaction kinetics. In some embodiments, the battery includes a heating element to heat the molten or heat-softened materials while also conducting current.

While many high temperature batteries have been commercialized, including thermal primary batteries and secondary sodium chloroaluminate or sodium sulfur batteries, all of them are constructed with metal housings. Illustrated embodiments show a battery system with a solid electrolyte and cell casings made from a polymer material rather than metal, resulting in considerable weight reduction. The polymer structural elements are in direct contact with high temperature active materials. Furthermore, the illustrated embodiments describe a set of weight saving structural motifs and an integrated heating system. Illustrated embodiments include a concept of operations in which the battery is heated by an external energy source, such as a battery charger, until it reaches its operating temperature, and then the battery transitions into a self-heating mode upon disconnection from the external energy source. Details of illustrative embodiments are discussed below.

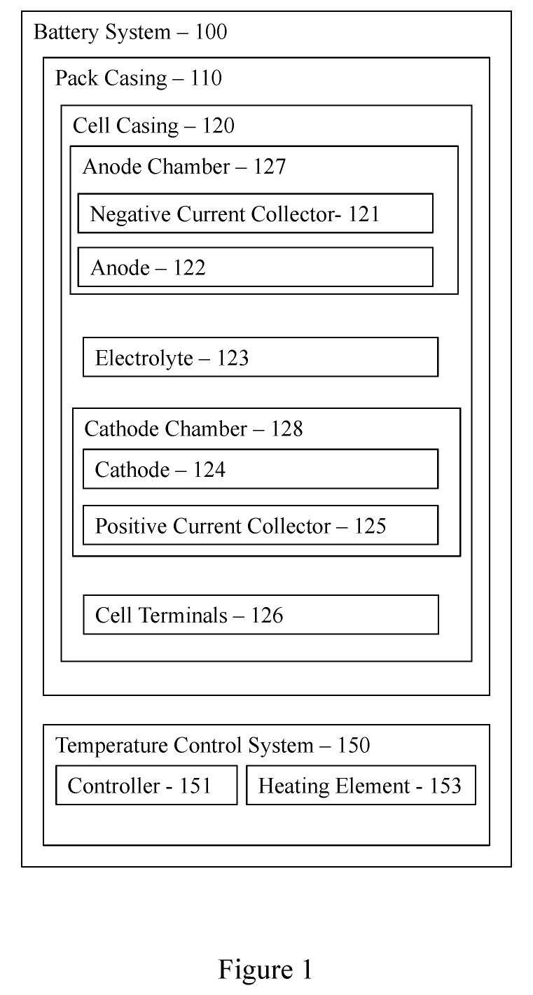

FIG. 1 is a block diagram showing a battery system 100 configured to store energy at a high-power density. It should be appreciated the battery system 100 may be implemented in a variety of applications, including electric-powered aircraft, to name but one example.

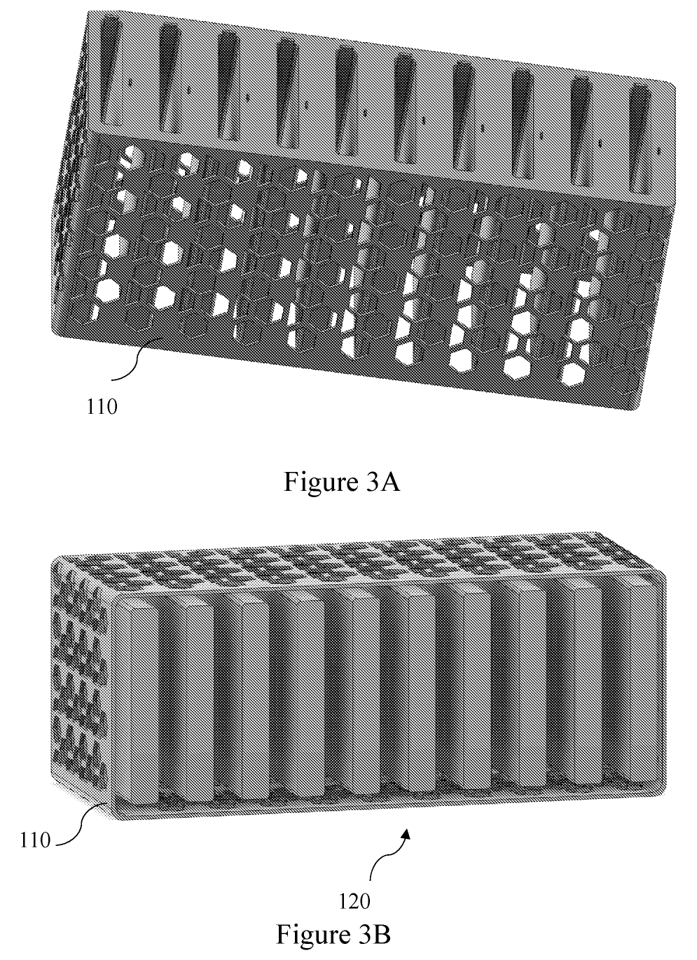

The battery system 100 has a pack casing 110 configured to couple battery cells together. As shown in FIGS. 3A and 3B, the pack casing may include cutouts to reduce the weight of the pack casing 110. The battery system 100 has cell casing 120 to enclose each battery cell. In some embodiments, the pack casing 110 forms a portion of the cell casing 120. In some embodiments, the pack casing 110 and the cell casing may be formed from a single polymer monolith.

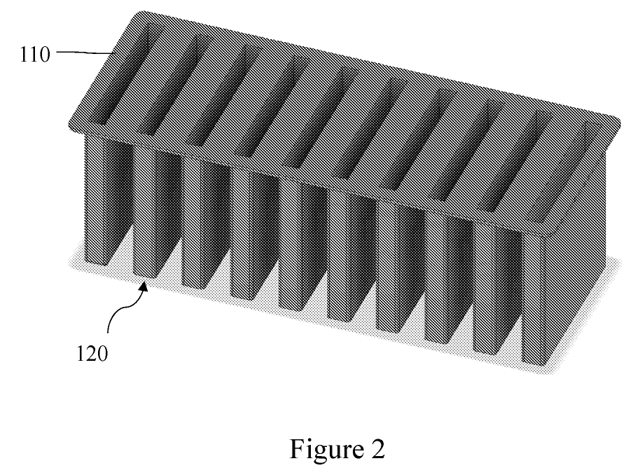

As shown in in FIGS. 2-3B, the arrangement of cell casings 120 forms voids between the cell casings 120. In some embodiments, the void may be filled by a thermally insulative material, such as foam insulating material, vacuum insulated panels, or 3D printed insulating foam, among other things.

The cell casing 120 and the pack casing 110 is comprised of polymer material which provides structural support for the other components of the battery system 100. The polymer material is configured to withstand high temperatures. For example, the polymer material may be stable and or chemically inert at the temperature corresponding to the melting point of the chemically active material contained within the casings 110, 120. The chemically active materials, which include an anode or cathode, may be molten, which includes having a temperature above the material melting point, or heat-softened, which includes having a temperature high enough to increase the malleability of the material. For example, the material may become heat-softened when heated to within 30% of its melting point. In some embodiments, the cell casing 120 or pack casing 110 may be comprised of at least one of Polyetheretherketone (PEEK), Polyetherimide (PEI), Polyurethene, polyacrylate, or polymethacrylate, among other things. In some embodiments, the cell casing 120 or pack casing 110 may be comprised of at least one of Polyimide (PI), Polytetrafluoroethylene (PTFE), Polyaryletherketone (PAEK), Polybenzimidazole (PBI), Polyarylsulfone (PAS), Polyetherketoneketone (PEKK), Polyphenylsulfone (PPSU), Polyvinylidene Fluoride (PVDF), Somos PerForm, or Somos PerForm Reflect, Formlabs High Temperature Resin, among other things.

In some embodiments, the cell casing 120 or the pack casing 110 consists of the polymer material. In some embodiments, the cell casing 120 or the pack casing 110 is comprised of at least 98% polymer by volume. In some embodiments, the cell casing 120 or the pack casing 110 is comprised of at least 90% polymer by volume. In some embodiments, the cell casing 120 or the pack casing 110 is comprised of at least 70% polymer by volume. In some embodiments, the cell casing 120 or the pack casing 110 is comprised of at least 50% polymer by volume. The remaining portion of the cell casing 120 or the pack casing 110 may include a non-polymer coating, such as a metalized coating. The remaining portion of the cell casing 120 or pack casing 110 may include a non-polymer infill, such as glass, carbon fiber, or ceramic, among other things. The infill be in the form of fibers or whiskers, among other things.

The cell casing 120 or the pack casing may be manufactured using stereolithography, computer numerical control (CNC) milling, 3D printing, or injection molding, among other things.

The interior chamber is configured to contain chemically active materials including lithium, sulfur, metal halides, metal chlorides, sulfides, redox polymers, or combinations thereof, among other things. In some embodiments, the interior chamber of the cell casing 120 has an anode chamber configured to contain an anode 122 and negative current collector 121. The anode 122 may include lithium, sulfides, metal halides or redox polymers, among other things. The current collector 121 is configured to transmit electric current between the anode 122 and the cell terminals 126. During operation of the battery system, the anode 122 may be molten lithium.

The interior chamber of the cell casing 120 also has a cathode chamber 128 configured to contain a cathode 124 and positive current collector 125. The current collector 125 is configured to transmit electric current between the cathode 124 and the cell terminals 126. The cathode 124 may include sulfur, carbon, metal halides, or metal chlorides, among other things. For example, the cathode may include molten sulfur, solid graphite, or graphene, among other things.

The cell casing 120 may have an interior chamber divided by an electrolyte 123 configured to transfer ions between the anode 122 and the cathode 124, also known as a bobbin-type battery arrangement. The interior chamber and the electrolyte 123 form the anode chamber 127 and the cathode chamber 128. In some embodiments, the electrolyte is conical or cylindrical, dividing an interior anode chamber 127 from an exterior cathode chamber 128. The electrolyte may also include a sheet shape, a disc shape, or a cup shape, among other things. The electrolyte 123 may be comprised of a solid polymer electrolyte, or a composite of a ceramic powder within a solid electrolyte.

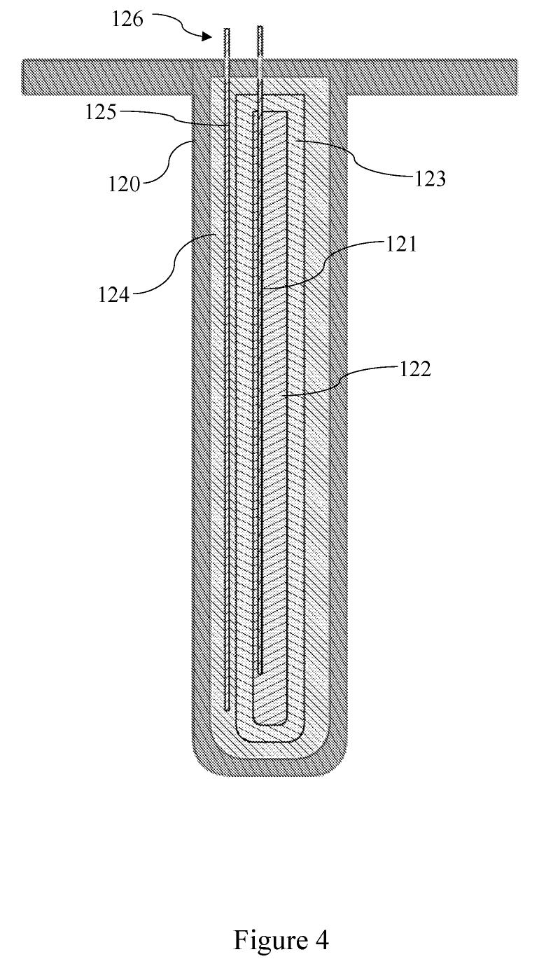

FIG. 4 shows a cross-sectional view of a battery cell arrangement positioned in one of the empty cell casing cavities illustrated in FIGS. 2-3A. The cell casing 120 encloses the other components of the battery cell positioned in the interior chamber of the cell casing 120. The interior chamber is further divided by the electrolyte 123 into an anode chamber containing the anode 122 and a cathode chamber containing the cathode 124. The negative current collector 121 is inserted into the anode chamber and the positive current collector is inserted into the cathode chamber. The cell terminals 126 protrude from the top of the cell casing 120 and may be mechanically coupled to cell terminals from other battery cells or the battery terminals. In some embodiments, the portion of the positive current collector 125 and the negative current collector 121 protruding from the cell casing may be understood to be the cell terminals 126.

Referring again to FIG. 1, the battery system 100 includes a temperature control system 150 configured to heat the anode 122 or the cathode 124 to a molten state. For example, the anode or cathode material may be heated by the system 150 to maintain a temperature of at least 125°C, within a range of 125°C-275°C, or within a range of 150°C-240°C.

The temperature control system 150 includes one or more heating elements 153. For example, one heating element 153 may be configured to heat the anode 122 to a molten state and another heating element 153 may be configured to heat the cathode 124 to a molten state.

In some embodiments, the heating elements 153 replace dedicated current collectors and are both thermally and electrically conductive. For example, the heating element 153 may be formed with metal tube housing which is electrically and thermally coupled to the anode 122 or the cathode 124.

The temperature control system 150 has a controller 151 to operate the heating element 153. In some embodiments, the controller 151 is configured to selectively provide power from an external power source to heating elements 153 of a portion of the cells of the battery system 100 to heat the portion of cells. The external power source may be a battery, battery charger, an ultracapacitor, or another device configured to provide power. After heating the portion of cells, the controller 151 uses power from the heated cells to heat the remaining cells. In some embodiments, the temperature control system 150 may be designed to use an external temperature source to heat the battery to its operating temperature in the range of 60 to 240°C, and then energy stored in the battery may be used to maintain that temperature during operation. In some embodiments, the temperature control system 150 draws power for bringing the battery to its initial operating temperature from the external source, and then maintains the internal temperature of the battery using energy stored in the battery itself.

In some embodiments, the battery system 100 includes a cooling system configured to remove heat from the anode chamber 127 or the cathode chamber 128. The cooling system may be inactive during normal operation but provides rapid cooling with refrigerant or coolant fluid in the event of an emergency. In some embodiments, the cell casing 120 or pack casing 110 include fluid channels for circulating fluid.

In some embodiments, the anode chamber 127 or cathode chamber 128 may be depressurized by way of a pressure releasing device. Among other things, the pressure releasing device may include a piston configure to selectively open the interior region.

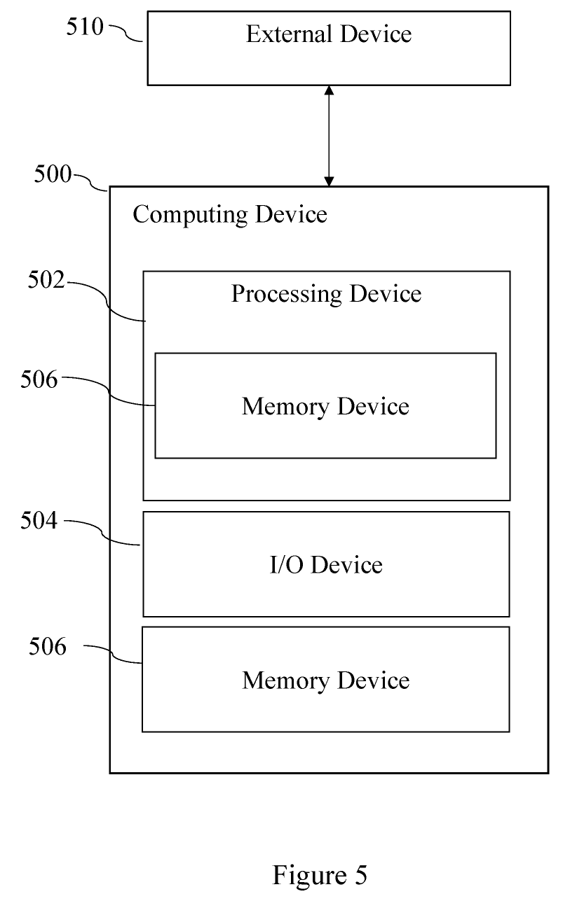

FIG. 5 schematically shows a computing device 500 in accordance with various embodiments. The computing device 500 is one example of a computing device of the battery system 100 illustrated in FIG. 1. The computing device 500 includes a processing device 502, an input/output device 504, and a memory device 506. The computing device 500 may be a stand-alone device, an embedded system, or a plurality of devices configured to perform the functions described with respect to the controller 151. Furthermore, the computing device 500 may communicate with one or more external devices 510.

The input/output device 504 enables the computing device 500 to communicate with an external device 510. For example, the input/output device 504 may be a network adapter, a network credential, an interface, or a port (e.g., a USB port, serial port, parallel port, an analog port, a digital port, VGA, DVI, HDMI, FireWire, CAT 5, Ethernet, fiber, or any other type of port or interface), among other things. The input/output device 504 may be comprised of hardware, software, or firmware. The input/output device 504 may have more than one of these adapters, credentials, interfaces, or ports, such as a first port for receiving data and a second port for transmitting data, among other things.

The external device 510 may be any type of device that allows data to be input or output from the computing device 500. For example, the external device 510 may be an external power source, a control system, a sensor, a mobile device, a reader device, equipment, a handheld computer, a diagnostic tool, a controller, a computer, a server, a printer, a display, a visual indicator, a keyboard, a mouse, or a touch screen display, among other things. Furthermore, the external device 510 may be integrated into the computing device 500. More than one external device may be in communication with the computing device 500.

The processing device 502 may be a programmable type, a dedicated, hardwired state machine, or a combination thereof. The processing device 502 may further include multiple processors, Arithmetic-Logic Units (ALUs), Central Processing Units (CPUs), Digital Signal Processors (DSPs), or Field-programmable Gate Arrays (FPGA), among other things. For forms of the processing device 502 with multiple processing units, distributed, pipelined, or parallel processing may be used. The processing device 502 may be dedicated to performance of just the operations described herein or may be used in one or more additional applications. The processing device 502 may be of a programmable variety that executes processes and processes data in accordance with programming instructions (such as software or firmware) stored in the memory device 506. Alternatively or additionally, programming instructions are at least partially defined by hardwired logic or other hardware. The processing device 502 may be comprised of one or more components of any type suitable to process the signals received from the input/output device 504 or elsewhere, and provide desired output signals. Such components may include digital circuitry, analog circuitry, or a combination thereof.

The memory device 506 in different embodiments may be of one or more types, such as a solid-state variety, electromagnetic variety, optical variety, or a combination of these forms, to name but a few examples. Furthermore, the memory device 506 may be volatile, nonvolatile, transitory, non-transitory or a combination of these types, and some or all of the memory device 506 may be of a portable variety, such as a disk, tape, memory stick, or cartridge, to name but a few examples. In addition, the memory device 506 may store data which is manipulated by the processing device 502, such as data representative of signals received from or sent to the input/output device 504 in addition to or in lieu of storing programming instructions, among other things. As shown in FIG. 5, the memory device 506 may be included with the processing device 502 or coupled to the processing device 502, but need not be included with both.

It is contemplated that the various aspects, features, processes, and operations from the various embodiments may be used in any of the other embodiments unless expressly stated to the contrary. Certain operations illustrated may be implemented by a computer executing a computer program product on a non-transient, computer-readable storage medium, where the computer program product includes instructions causing the computer to execute one or more of the operations, or to issue commands to other devices to execute one or more operations.

While the present disclosure has been illustrated and described in detail in the drawings and foregoing description, the same is to be considered as illustrative and not restrictive in character, it being understood that only certain exemplary embodiments have been shown and described, and that all changes and modifications that come within the spirit of the present disclosure are desired to be protected. It should be understood that while the use of words such as “preferable,” “preferably,” “preferred” or “more preferred” utilized in the description above indicate that the feature so described may be more desirable, it nonetheless may not be necessary, and embodiments lacking the same may be contemplated as within the scope of the present disclosure, the scope being defined by the claims that follow. In reading the claims, it is intended that when words such as “a,” “an,” “at least one,” or “at least one portion” are used there is no intention to limit the claim to only one item unless specifically stated to the contrary in the claim. The term “of” may connote an association with, or a connection to, another item, as well as a belonging to, or a connection with, the other item as informed by the context in which it is used. The terms “coupled to,” “coupled with” and the like include indirect connection and coupling, and further include but do not require a direct coupling or connection unless expressly indicated to the contrary. When the language “at least a portion” or “a portion” is used, the item can include a portion or the entire item unless specifically stated to the contrary. Unless stated explicitly to the contrary, the terms “or” and “and/or” in a list of two or more list items may connote an individual list item, or a combination of list items. Unless stated explicitly to the contrary, the transitional term “having” is open-ended terminology, bearing the same meaning as the transitional term “comprising.”

Various embodiments of the invention may be implemented at least in part in any conventional computer programming language. For example, some embodiments may be implemented in a procedural programming language (e.g., “C”), or in an object-oriented programming language (e.g., “C++”). Other embodiments of the invention may be implemented as a pre-configured, stand-alone hardware element and/or as preprogrammed hardware elements (e.g., application specific integrated circuits, FPGAs, and digital signal processors), or other related components.

In an alternative embodiment, the disclosed apparatus and methods (e.g., see the various flow charts described above) may be implemented as a computer program product for use with a computer system. Such implementation may include a series of computer instructions fixed either on a tangible, non-transitory medium, such as a computer readable medium (e.g., a diskette, CD-ROM, ROM, or fixed disk). The series of computer instructions can embody all or part of the functionality previously described herein with respect to the system.

Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies.

Among other ways, such a computer program product may be distributed as a removable medium with accompanying printed or electronic documentation (e.g., shrink wrapped software), preloaded with a computer system (e.g., on system ROM or fixed disk), or distributed from a server or electronic bulletin board over the network (e.g., the Internet or World Wide Web). In fact, some embodiments may be implemented in a software-as-a-service model (“SAAS”) or cloud computing model. Of course, some embodiments of the invention may be implemented as a combination of both software (e.g., a computer program product) and hardware. Still other embodiments of the invention are implemented as entirely hardware, or entirely software.

The embodiments of the invention described above are intended to be merely exemplary; numerous variations and modifications will be apparent to those skilled in the art. Such variations and modifications are intended to be within the scope of the present invention as defined by any of the appended claims. It shall nevertheless be understood that no limitation of the scope of the present disclosure is hereby created, and that the present disclosure includes and protects such alterations, modifications, and further applications of the exemplary embodiments as would occur to one skilled in the art with the benefit of the present disclosure.

What is claimed is:

1. A battery system comprising:
a casing comprising a polymer, the casing forming an interior chamber; and
a chemically active material contained by the interior chamber,
wherein the polymer is configured to withstand heat generated by the chemically active material, the heat being a function of a melting point of the chemically active material.

2. The battery system of claim 1, wherein at least 70% of the casing by volume is comprised of the polymer.

3. The battery system of claim 1, wherein the polymer is comprised of a least one of
polyetheretherketone (PEEK), polyetherimide (PEI), a polyurethane, a polyacrylate, or a polymethacrylate, and wherein the chemically active material includes molten or heat-softened lithium.

4. The battery system of claim 1, wherein the casing is 3D printed.

5. The battery system of claim 1, wherein the interior chamber is divided into an anode chamber and a cathode chamber, and the battery system includes a temperature control system configured to separately adjust a first temperature of the anode chamber and a second temperature of the cathode chamber.

6. The battery system of claim 1, wherein the battery system includes a temperature control system including a heating element electrically coupled to the chemically active material.

7. The battery system of claim 6, wherein the temperature control system includes a controller configured to heat, using the heating element, the chemically active material as a function of the melting point of the chemically active material.

8. The battery system of claim 1, wherein the interior chamber is divided into an anode chamber and a cathode chamber by a solid electrolyte.

9. The battery system of claim 1, wherein the casing is a cell casing, and wherein the battery system comprises a pack casing comprising a second polymer.

10. The battery system of claim 9, comprising a plurality of cells and a temperature control system, the temperature control system being configured to heat a first portion of the plurality of cells using an external power source and heat the remaining portion of the plurality of cells using the first portion of the plurality of cells.

11. A battery system comprising:
a polymer casing forming an interior chamber; and
molten or heat-softened lithium contained by the interior chamber.

12. The battery system of claim 11, wherein the polymer casing is comprised of at least 70% polymer and infill by volume.

13. The battery system of claim 12, wherein the polymer is comprised of a least one of polyetheretherketone (PEEK), polyetherimide (PEI), a polyurethane, a polyacrylate, or a polymethacrylate.

14. The battery system of claim 11, wherein the casing is 3D printed.

15. The battery system of claim 11, wherein the interior chamber is divided into an anode chamber and a cathode chamber, and the battery system includes a temperature control system configured to separately adjust a first temperature of the anode chamber and a second temperature of the cathode chamber.

16. The battery system of claim 11, wherein the battery system includes a temperature control system including a heating element electrically coupled to the molten lithium.

17. The battery system of claim 16, wherein the temperature control system includes a controller configured to heat, using the heating element, the molten lithium as a function of a melting point of molten lithium.

18. The battery system of claim 11, wherein the interior chamber is divided into an anode chamber and a cathode chamber by a solid electrolyte.

19. The battery system of claim 11, wherein the casing is a cell casing, and wherein the battery system comprises a pack casing comprising a second polymer.

20. The battery system of claim 19, comprising a plurality of cells and a temperature control system, the temperature control system being configured to heat a first portion of the plurality of cells using an external power source and heat the remaining portion of the plurality of cells using the first portion of the plurality of cells.

21. The battery system of claim 11, comprising a temperature control system, wherein the temperature control system heats the battery system to an initial operating temperature using an external power source and maintains a battery temperature using energy stored by the battery system.
